(19) United States
(12) Patent Application Publication
(10) Pub. No.: US 2024/0003425 A1
(43) Pub. Date: Jan. 4, 2024

(54) THREE-WAY VALVE FOR HIGH-PRESSURE GAS TANK

(71) Applicant: FAURECIA SYSTEMES D'ECHAPPEMENT, NANTERRE (FR)

(72) Inventor: Sullivan ICARD, THIONVILLE (FR)

(21) Appl. No.: 18/210,733

(22) Filed: Jun. 16, 2023

(30) Foreign Application Priority Data
Jun. 29, 2022 (FR) 22 06518

(51) Int. Cl. F16K 1/30; F16K 11/02; F16K 1/38; F16K 1/02; F16K 5/04

(52) U.S. Cl. CPC F16K 1/302; F16K 11/02; F16K 1/38; F16K 1/02; F16K 5/0407; F16K 5/0442

(57) ABSTRACT

A valve comprises a body that includes a first channel connected to the gas tank and a second channel connected to a circuit, with the first and second channels communicating with a central housing. The valve comprises a closure member movable between a closed position of the first channel and a supply position in which the first and second channels communicate. A third channel is formed in the body and communicates with the central housing The closure member is configured to isolate the third channel from the first and second channels in the closure and supply positions, and to allow communication between the third channel and the first and second channels in a discharge position.

### CROSS-REFERENCE TO RELATED APPLICATION

This application is a U.S. non-provisional application claiming the benefit of French Application No. 22 06518, filed on Jun. 29, 2022, which is incorporated herein by reference in its entirety.

### TECHNICAL FIELD

The present disclosure relates to a valve for a high-pressure gas tank, in particular a hydrogen tank. Such a tank is in particular intended to supply a fuel cell system, for example for a vehicle.

### BACKGROUND

Already known in the state of the art is a manual valve of a high-pressure gas tank, intended to make the gas tank communicate with a circuit in the open position, or to isolate them in the closed position.

The gas tank is generally also equipped with a purge valve, making it possible to discharge gas directly into a high pressure line of the fuel cell system without the need to supply the electric valve.

Both of these valves are generally expensive, so that the purpose of the disclosure is in particular to reduce the cost of a gas tank.

### SUMMARY

A valve is provided that is intended to equip a high-pressure gas tank, in particular a hydrogen tank, for example for a vehicle. The valve comprises a body that includes a first channel intended to be connected to the gas tank, and a second channel intended to be connected to a circuit, with the first and second channels communicating with a central housing. The valve comprises a closure member movable between a closed position of the first channel and a supply position in which the first and second channels communicate. A third channel is arranged in the body and communicates with the central housing. The closure member is configured to isolate the third channel from the first and second channels in the closure and supply positions, and to allow communication between the third channel and the first and second channels in a discharge position.

According to the disclosure, the same element performs both functions of manual and discharge valves. The cost is thus reduced relative to a tank comprising two distinct valve devices.

A valve according to the disclosure may further comprise one or several of the following features, considered alone or according to any technically conceivable combination:
The closure member comprises a first element movable in translation along a longitudinal axis, the first channel being arranged facing the first element in the longitudinal direction, so that the first element closes the first channel in the closure position.
The first element comprises a frustoconical end portion, extending between a proximal base having a diameter greater than that of the first channel, and a distal base having a diameter smaller than that of the first channel, the frustoconical end portion being arranged facing the first channel so as to be able to be inserted thereinto when the first element moves toward this first channel.
The first element comprises a proximal annular seal intended to be compressed against an internal wall of the central housing.
The closure member comprises a second element movable by screwing along the longitudinal axis, cooperating with the first element in order to move the first element when the second element is actuated.
The valve comprises a third fixed element wherein the second element is movable by screwing, the third element comprising a stop for the second element in the discharge position.
The central housing comprises a distal seal, arranged between the first channel and the third channel, and the first element comprises a passage part, allowing the passage of gas by bypassing the distal seal when this passage portion is facing this distal seal, the first and third channels not communicating when the passage portion is not facing the distal seal.
The passage portion comprises a helical groove, dimensioned such that, in the discharge position, the ends of the helical groove are located on either side of the distal seal.
The passage portion comprises a duct, dimensioned such that, in the discharge position, the ends of the duct are located on either side of the distal seal.

The disclosure also relates to a high-pressure gas tank, in particular for hydrogen, wherein it comprises a valve as defined above.

### BRIEF DESCRIPTION OF THE DRAWINGS

Other aspects and advantages of the disclosure will become apparent on reading the following description, given solely by way of example and made with reference to the appended drawings, in which:

FIG. 1 schematically depicts a valve according to a first exemplary embodiment of the disclosure, in a first closed manual valve configuration;

FIG. 2 schematically depicts a closure member equipping the valve of FIG. 1;

FIG. 3 is a view similar to FIG. 1 of the valve in a second open manual valve configuration, corresponding to normal use;

FIG. 4 is a view similar to FIG. 1 of the valve in a third purge configuration, for purging the system in the event of electric valve failure; and

FIG. 5 is a view similar to FIG. 1 of a valve according to a second embodiment of the disclosure.

### DETAILED DESCRIPTION

In all the figures, analogous elements from one figure to another are designated by identical references.

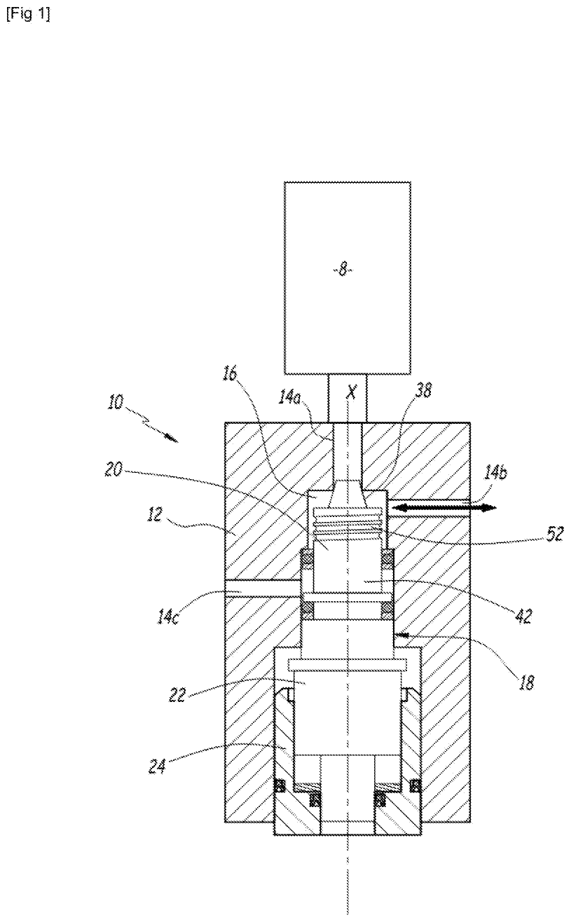

FIG. 1 shows a valve 10 intended to equip a high-pressure gas tank 8, in particular a hydrogen tank. For example, the gas tank is intended to equip a fuel cell system, in particular for a vehicle.

The valve 10 comprises a body 12, in which three channels are formed, called first channel 14a, second channel 14b and third channel 14c.

The first channel 14a is intended to be connected to the gas tank.

The second channel 14b forms an outlet of the valve 10 intended to be connected to a circuit of the fuel cell system for normal operation.

The third channel 14c forms a bypass orifice, intended to provide a purge function, in a manner known per se.

The three channels communicate with a central housing 16. The central housing 16 extends in a longitudinal direction along a longitudinal axis X. It will be noted that the valve 10 extends, in the longitudinal direction, between a proximal end and an opposite distal end.

In the present disclosure, the term proximal refers to the end from which the valve 10 can be actuated, and the term distal denotes the end opposite the proximal end. In the figures, the proximal end is at the bottom, and the distal end at the top.

The first channel 14a is arranged at the distal end, and extends for example parallel to the longitudinal direction, preferably coaxially with the longitudinal axis X.

The second channel 14b is arranged near the distal end, although closer to the proximal end than the first channel 14a. The second channel 14b extends, for example, perpendicularly to the longitudinal direction.

The third channel 14c is arranged closer to the proximal end than the second channel 14b. Thus, the second channel 14b is in the longitudinal direction between the first channel 14a and the third channel 14c. The third channel 14c extends, for example, perpendicularly to the longitudinal direction.

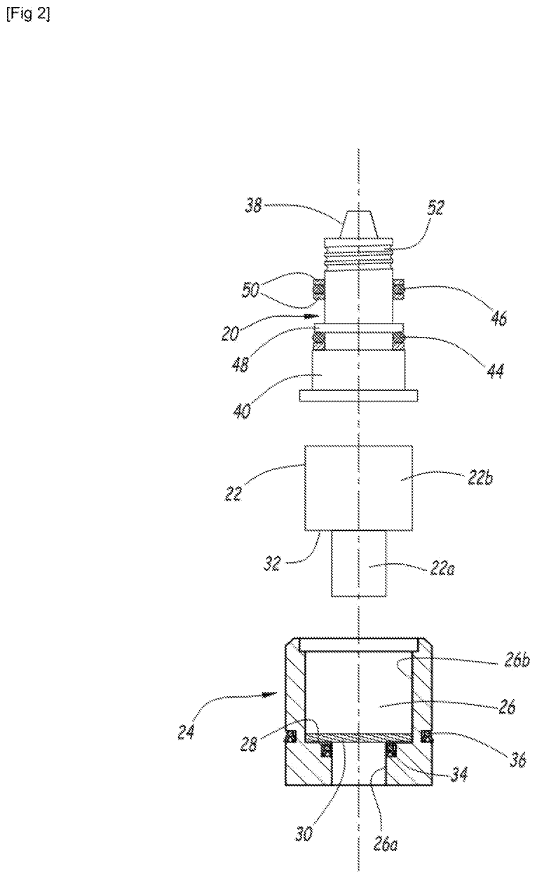

The valve 10 comprises a closure member 18, housed in the central housing 16. The closure member 18 is shown, alone, in more detail in FIG. 2.

The closure member 18 comprises a first element 20, a second element 22, and a third element 24.

The third element 24 is fixed and intended to be fixed in the central housing 16, at the proximal end of the valve 10.

The second element 22 is movable, preferably by screwing along the longitudinal axis X. For example, the second element 22 and the third element 24 comprise complementary threads cooperating so that a rotation of the second element 22 drives its movement, by screwing, along the longitudinal axis.

The first element 20 is movable, preferably by translation along the longitudinal axis X. The first element 20 is driven in translation by the second element 22, when the latter moves.

The third element 24 is hollow and intended to partially house the second element 22. More particularly, the third element 24 comprises a through cavity 26 comprising a proximal cavity portion 26a and a distal cavity portion 26b. The through cavity 26 has a general shape of revolution defined about the longitudinal axis X, with a larger diameter in the distal cavity portion 26b than in the proximal cavity portion 26a.

Thus, the proximal 26a and distal 26b cavity portions are separated by a cavity shoulder 28. The cavity shoulder 28 is preferably covered with a stop ring 30, for example made of rubber.

The second element 22 has a general shape of revolution about the longitudinal axis X and comprises a first shaft portion 22a and a second shaft portion 22b. The second shaft portion 22b has a diameter greater than that of the first shaft portion 22a. Thus, the first 22a and second 22b shaft portions are separated by a shaft shoulder 32.

The second element 22 is accommodated in the through cavity 26, with the first shaft portion 22a in the first cavity portion 26a, and the second shaft portion 22b in the second cavity portion 26b.

The shaft shoulder 32 is capable of abutting with the cavity shoulder 28, and more particularly with the stop ring 30.

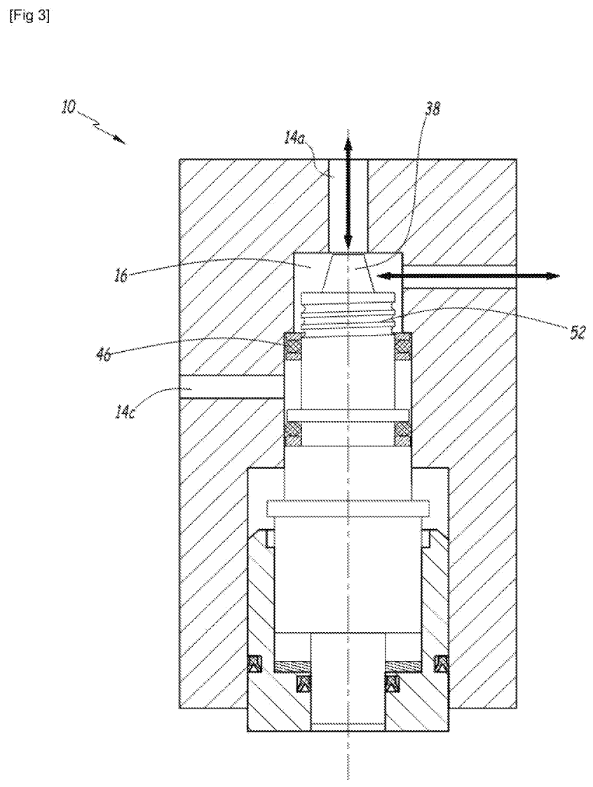

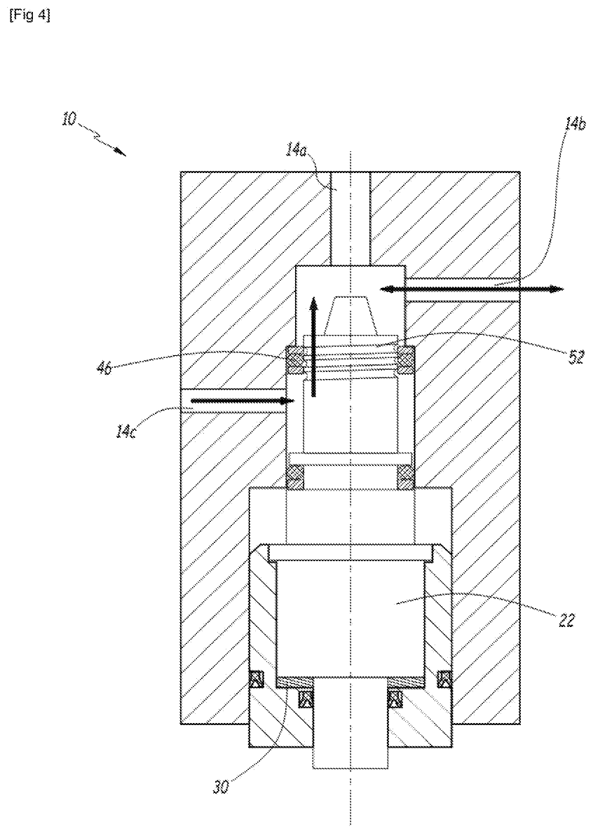

It will be noted that the length of the first shaft portion 22a is provided to give visual information of the status of the valve. Thus, when the shaft portion 22a is in negative pressure at the end of the body 24 (FIG. 1), the manual valve is closed. When the shaft portion 22a is substantially flush with the end of the body 24 (FIG. 3), the manual valve is open. Finally, when the shaft portion 22a protrudes from the end of the body 24 (FIG. 4), then the purge valve is activated.

The third element 24 comprises, in the first cavity portion 26a, a first circular seal 34, intended for being compressed between the first shaft portion 22a and an inner wall of the first cavity portion 26a. This first seal 34 makes it possible to prevent ingress of water, dust or other external attack through the first cavity portion 26a.

The third element 24 also comprises, on an outer wall, a second circular seal 36, intended to be compressed between this outer wall and an inner wall of the central housing 16 of the body 12. This second seal 36 makes it possible to prevent ingress of water, dust or other external attack by the proximal end of the central housing 16.

Advantageously, at least one of the first 26a and second 26b cavity portions comprises a thread, and at least one of the first 22a and second 22b shaft portions includes a complementary thread, such that the second member 22 is screwed into the third member 24. The second element 22 is therefore movable by screwing along the longitudinal axis X. In other words, a rotation of the second element 22 drives this second element in motion in the direction of the longitudinal axis X.

The first element 20 is movable in translation along the longitudinal axis X, in particular by being pushed by the second element 22 in a first direction considered from the proximal end toward the distal end.

It will be noted that the first element 20, being located on the distal side relative to the second element 22, is pressed against the second element 22 under the effect of the pressure in the tank. Thus, when the second member 22 is moved towards the proximal end, the first element 20 is also moved toward this proximal end.

Alternatively, the valve could comprise a way for elastically returning the first element to the proximal end.

The first element 20 is configured to close or clear some of the channels 14a, 14b or 14c, in particular the first 14a and third 14c channels, depending on the position of the first element 20 in the central housing 16.

The first element 20 comprises, at its distal end, a frustoconical end portion 38, extending between a proximal base having a diameter greater than that of the first channel 14a (in particular of a mouth of the first channel 14a), and a distal base having a diameter smaller than that of the first channel 14a (in particular the mouth). The frustoconical portion 38 is arranged facing the first channel 14a, so as to be able to be inserted thereinto when the first element 20 moves toward the distal end.

The first element 20 further comprises, at its proximal end, a bearing block 40 intended to bear against the second element 22.

The first element 20 also comprises, adjacent to the bearing block 40, an intermediate portion 42, delimited longitudinally by a proximal annular seal 44. The proximal annular seal 44 is held by a proximal annular protuberance 48. The proximal annular seal 44 is intended to be compressed against an inner wall of the housing 16. This proximal annular seal 44 makes it possible to avoid gas leaks.

On the other hand, the intermediate portion 42 has a diameter smaller than that of the inner wall of the housing 16, so as to leave a circumferential clearance between this intermediate portion 42 and the inner wall of the housing 16.

The housing 16 further comprises a distal annular seal 46 fixed in this housing 16, by annular retaining elements 50. The distal annular seal 46 is intended to ensure an internal seal between the inner wall of the housing 16 and the intermediate portion 42.

Lastly, the first element 20 comprises a gas passage portion 52, arranged between the intermediate portion 42 and the end portion 38. According to the first embodiment, the passage portion 52 comprises a helicoidal groove, forming a thread. The groove thus has a maximum diameter (corresponding to the top of the groove) substantially equal to the diameter of the intermediate portion 42, and a minimum diameter (corresponding to the hollow of the groove) less than the maximum diameter.

The different positions of the first element 20 in the valve 10 will now be described with reference to FIGS. 1, 3 and 4.

FIG. 1 shows a closure position. In this closure position, the second element 22 is pushed as far as possible toward the distal end. The frustoconical end portion 38 is thus pressed into the first channel 14a, so that this first channel 14a is closed. Although the second channel 14b communicates with the housing 16, it is isolated from the first channel 14a. The gas present in the tank therefore does not flow in the circuit.

Furthermore, in this closing position, the intermediate portion is facing the third channel 14c. The gas passage portion 52 is located above the distal seal 46. Thus, the third channel 14c is also isolated from the second channel 14b by the distal seal 46 which is compressed between the inner wall of the housing 16 and the intermediate portion 42.

FIG. 3 shows a supply position. In this supply position, the second element 22 is separated from the distal end such that the frustoconical end portion 38 no longer closes the first channel 14a. The first channel 14a then communicates with the second channel 14b, which allows the supply of the gas circuit from the tank.

The first element 20 is dimensioned so that, in this supply position, the gas passage portion 52 remains above the distal seal 46. Thus, the third channel 14c remains isolated from the first 14a and second 14b channels by the distal seal 46 which is compressed between the inner wall of the housing 16 and the intermediate portion 42.

FIG. 4 shows a discharge position. In this discharge position, the frustoconical end portion 38 remains separated from the first channel 14a and does not close it.

In this discharge position, the gas passage portion 52 extends on either side of the distal seal 46, so that the gas is likely to go beyond this distal seal 46, through the passage portion 52, in particular by following the helicoidal groove. Thus, in this discharge position, the third channel 14c communicates with the first 14a and second 14b channels.

It will be noted that, in the discharge position, the second element 22 abuts against the stop ring 30. Thus, the position of the first 20 and second 22 elements is fixed by this stop, which makes it possible to ensure proper positioning of the gas passage portion 52 relative to the distal seal 46 in the discharge position.

It is clearly apparent that the disclosure makes it possible to provide the three functions of closing, supplying, and discharging using a single valve 10, with only the movement of the second element 22 (which drives the first element 20).

The second element 22 can be driven in rotation in any conceivable way, for example by a motor, not shown.

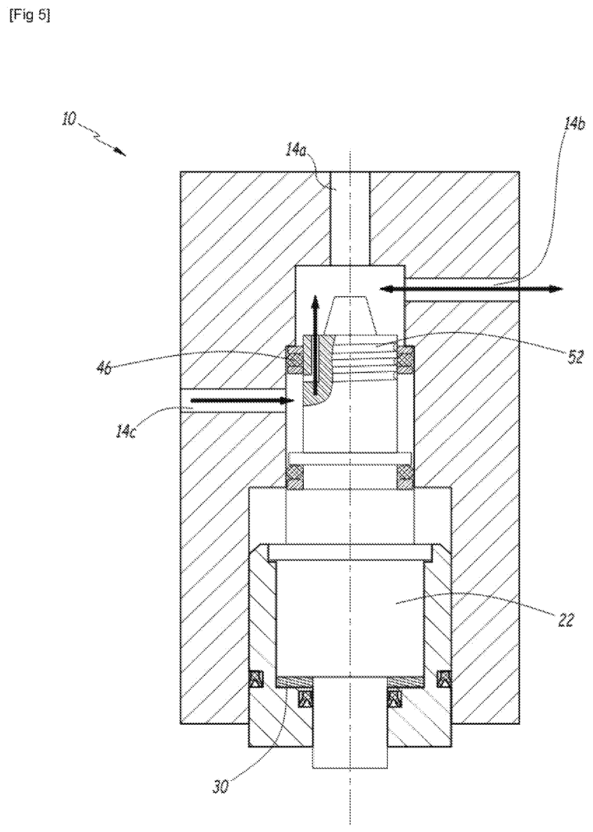

FIG. 5 shows a valve 10 according to a second exemplary embodiment of the disclosure.

The difference with the valve of the first embodiment is located in the passage portion 52. The rest of the valve is identical to that of the first embodiment.

According to this second embodiment, the passage portion 52 comprises a duct 54, configured to emerge, in the discharge position (that is to say, when the second element 22 abuts against the stop ring 30), on either side of the distal seal 46, as shown in FIG. 5.

Thus, the gas may go beyond the distal seal 46 through the duct 54. Thus, in this discharge position, the third channel 14c communicates with the first 14a and second 14b channels.

It will be noted that the disclosure is not limited to the embodiments described above and could have other variants remaining within the scope of the claims.

1. A valve intended to be fitted to a high-pressure gas tank, comprising:
a body including a first channel intended to be connected to the high-pressure gas tank and a second channel intended to be connected to a circuit, the first and second channels communicating with a central housing;
a closure member movable between a closing position of the first channel and a supply position wherein the first and second channels communicate; and
a third channel arranged in the body to communicate with the central housing, wherein the closure member is configured to isolate the third channel from the first and second channels in the closing and supply positions, and to allow communication between the third channel and the first and second channels in a discharge position.

2. The valve according to claim 1, wherein the closure member comprises a first element movable in translation along a longitudinal axis, the first channel being arranged facing the first element in a longitudinal direction, such that the first element closes the first channel in a sealing position.

3. The valve according to claim 2, wherein the first element comprises a frustoconical end portion, extending between a proximal base having a diameter greater than that of the first channel, and a distal base having a diameter smaller than that of the first channel, the frustoconical end portion being arranged facing the first channel, so as to be able to be inserted thereinto when the first element moves toward the first channel.

4. The valve according to claim 2, wherein the first element comprises a proximal annular seal intended for being compressed against an inner wall of the central housing.

5. The valve according to claim 2, wherein the closure member comprises a second element movable by screwing along the longitudinal axis, cooperating with the first element in order to move the first element when the second element is actuated.

6. The valve according to claim 5, comprising a third fixed element, in which the second element is movable by screwing, the third fixed element comprising a stop for the second element in the discharge position.

7. The valve according to claim 2, wherein the central housing comprises a distal seal, arranged between the first channel and the third channel, and the first element comprises a passage portion, allowing a passage of gas by bypassing the distal seal when the passage portion is opposite the distal seal, the first and third channels not communicating when the passage portion is not facing the distal seal.

8. The valve according to claim 7, wherein the passage portion includes a helical groove, dimensioned such that, in the discharge position, ends of the helical groove are located on either side of the distal seal.

9. The valve according to claim 7, wherein the passage portion comprises a duct, dimensioned such that, in the discharge position, ends of the duct are located on either side of the distal seal.

10. A high-pressure gas tank, characterized in that it comprises the valve according to claim 1.
